(19) United States
(12) Patent Application Publication
(10) Pub. No.: US 2004/0217681 A1
(43) Pub. Date: Nov. 4, 2004

(54) Display device with light-shielding substrate and method for fabricating the same

(76) Inventors: Jin-Woo Park, Yongin-si (KR); Byung-Hee Kim, Yongin-si (KR)

Correspondence Address: Robert E. Bushnell, 1522 K Street, N.W., Suite 300, Washington, DC, 20005, US

(21) Appl. No.: 10/835,565

(22) Filed: Apr. 30, 2004

(30) Foreign Application Priority Data
May 2, 2003 (KR) 2003-28314

(51) Int. Cl. H01J 61/40; H01K 1/30; H01K 1/26

(52) U.S. Cl. 313/110; 313/512; 313/495

(57) ABSTRACT

A flat panel display device and process incorporating a light-shield formed on either on a substrate or an encapsulation substrate, blocking ambient external light so that contrast and efficiency are improved, may be constructed with a substrate, a display device formed on the substrate, and an encapsulation substrate that encapsulates the display device. At least one of the substrate and the encapsulation substrate have protrusions for emitting a light emitted from the display device, with each of the protrusions including an aperture on its top surface, and a light-shield. The light-shield includes a light-reflecting layer selectively formed on a side wall of each of the protrusions reflecting internally generated light, and a light-shielding layer formed on the light-reflecting layer to block external light.

### CLAIM OF PRIORITY

This application claims the benefit of Korean Patent Application No. 2003-28314, filed on May 2, 2003, under 35 U.S.C. § 119, the entirety of which is hereby incorporated by reference.

### BACKGROUND OF THE INVENTION

1. Field of the Invention

The present invention relates to a flat panel display device and, more particularly, to a flat panel display device with a light-shielding substrate capable of improving contrast, and to a method of fabricating flat panel display devices.

2. Description of the Related Art

Generally, in flat panel display devices such as an OELD (Organic Electroluminescent Display) or an FED (Field Emission Display) device, the visual contrast of the images broadcast by the display devices are substantially degraded in the presence of external light. In a conventional flat panel display device, a black matrix is formed so that the deterioration of the contrast due to the incidental illumination of the flat panel of the display device with external light is prevented. Prior art methods however, for shielding the external light by using a black matrix, are, in fact, difficult to implement because it is difficult to create a black color by completely shielding a light-emitting area from external light. Meanwhile, a suggestion has been made in U.S. Pat. No. 5,596,246 entitled High Contrast TFEL Display In Which Light From The Transparent Phosphor Layer Is Reflected By An Electrode Layer And The TFEL Diffuse Reflectance <About 2% issued on the 21^{st} of January 1997 to R. A. Budzilek et al, to use a polarizer to shield the flat panel of an OELD from external light. Although the use of a polarizer in the OELD results in the shielding of the OELD from external light, thereby improving the contrast, there are problems however, with the OELD because the efficiency of the organic electroluminescent device is reduced, resulting in a reduced lifetime because approximately 50% or more of the light emitted from a light-emitting layer of the device is shielded by the polarizer.

An attempt has been made to form a cathode electrode with a black matrix layer instead of by using a polarizer, in order to shield the OELD from external light. There are also problems with this method however, because 50% or more of a light emitted from the light-emitting layer of the organic electroluminescent device, as well as the external light, is blocked. Furthermore, there is another problem with active matrix display devices because a black matrix layer must be formed even in the non-aperture portion due to a low aperture ratio.

### SUMMARY OF THE INVENTION

Therefore, the present invention has been made to solve the aforementioned problems of the prior art, and it is one object of the present invention to provide an improved flat panel visual display device and an improved process for constructing a flat panel visual display device.

It is another object to provide a flat panel display device with a light-shielding substrate capable of improving visual contrast, and a method of fabricating a flat panel display with a light-shielding substrate.

It is still another object to provide a flat panel display device with a light-shielding substrate exhibiting improved visual contrast and increased efficiency without reducing the aperture ratio, and a method of fabricating a flat panel display device exhibiting improved visual contrast and increased efficiency.

It is a yet another object to provide a flat panel display with a light-shielding substrate capable of blocking external light without loss of internal light by forming a roughness on a substrate, and a method of fabricating a flat panel visual display device that is able to block external light without loss of internal light, and a process for fabricating a visual display device with a roughness formed on a substrate.

In accordance with one aspect of the present invention, there is provided a translucent substrate for a flat panel display device that may be constructed with a plurality of protrusions each including an aperture, and a light-shielding film to block incident light. The light-shielding film may be formed on a surface of the substrate including the protrusions, except for the apertures.

The substrate is either a layer on which a display device is formed, or an encapsulation substrate, and may be either glass or a plastic substrate. The protrusions are formed integrally with the substrate, and a slanted angle between a inner side of each of the protrusions and the base of the substrate ranges from approximately 45° to approximately 90°.

The light-shielding film may be constructed with either a light organic black layer, an inorganic black layer, a carbon black layer, or with a layer having a concentration gradient of metal and transparent materials, able to absorb the incident light, or the light-shielding film may be constructed as a laminated layer structure of a thin metal film having a high reflectivity and an inorganic film so that the incident light is eliminated by interference.

In accordance with another aspect of the present invention, there is provided a substrate for a flat panel display device that may be constructed with a plurality of protrusions each including an aperture; a light-reflecting film formed on a surface of the substrate including the protrusions, but excluding the apertures; and a light-absorbing film formed on the light-reflecting film.

In accordance with yet another aspect of the present invention, there is provided a substrate for a flat panel display device that may be constructed with a plurality of light-emitting elements each including an aperture; and a light-shield formed on surfaces of the light-emitting means, but not on the apertures, with the light-emitting elements formed integrally with the substrate.

The light-emitting element may be constructed with a protrusion having an aperture on its top surface, a slanted angle between an inner side of each of the protrusions and the base of the substrate ranging from approximately 45° to approximately 90°; and a light-shield selectively formed on side walls of the protrusions excluding the apertures.

The light-shield includes a light-reflecting layer formed on side walls of the protrusions to reflect internal light; and a light-absorbing layer formed on the light-reflecting layer to absorb external light so that the external light is shielded. The light-reflecting layer maybe constructed with a metal film having a high reflectivity, and the light-absorbing layer may be constructed with an organic black layer, an inorganic black layer, a carbon black layer, or a concentration gradient layer of metal and inorganic materials.

The light-shield includes a light-reflecting layer formed on side walls of the protrusions to reflect an internal light, and a light-interfering layer formed on the light-reflecting layer in order to shield external light by eliminating the external light by interference. The light-reflecting layer may be constructed with a thicker metal film having a high reflectivity, and the light-interfering layer may be constructed with a thinner metal film having a high reflectivity and an inorganic film.

In accordance with yet another aspect of the present invention, there is provided a flat panel display device that may be constructed with a substrate; a display device formed on the substrate; and an encapsulation substrate that encapsulates the display device. At least one of the substrate and the encapsulation substrate may be constructed with a plurality of protrusions that provide the light emitted from the display device. Each of the protrusions should include an aperture on its top surface, and a light-shield selectively formed only on side walls of the protrusions, but not upon the apertures of the protrusions.

In accordance with yet another aspect of the present invention, a flat panel visual display device may be constructed with a substrate; a display device formed on the substrate; an encapsulation substrate for encapsulating the display device; and a light-shielding film attached on at least one of the substrate and the encapsulation substrate. The film may be constructed with protrusions that provide the light emitted by the display device, and each of the protrusions should include an aperture on its top surface. A light-shield should be selectively formed only on side walls of the protrusions.

### BRIEF DESCRIPTION OF THE DRAWINGS

A more complete appreciation of the invention, and many of the attendant advantage thereof, will be readily apparent as the same becomes better understood by reference to the following detailed description when considered in conjunction with the accompanying drawings in which like reference symbols indicate the same or similar components, wherein:

FIG. 1 is a partial cross-sectional view of a display device with a light-shielding encapsulation substrate according to a first embodiment of the present invention;

FIG. 2 is a partial cross-sectional view of a display device with a light-shielding substrate according to a second embodiment for the practice of the present invention;

FIGS. 3A to 3E are partial cross-sectional views illustrating a method of manufacturing a light-shielding substrate of the present invention; and

FIG. 4 is a schematic perspective view illustrating a representation of the light-shielding substrate for the practice of the present invention.

### DESCRIPTION OF THE PREFERRED EMBODIMENTS

Hereinafter, embodiments of the present invention will be described in detail the accompanying drawings.

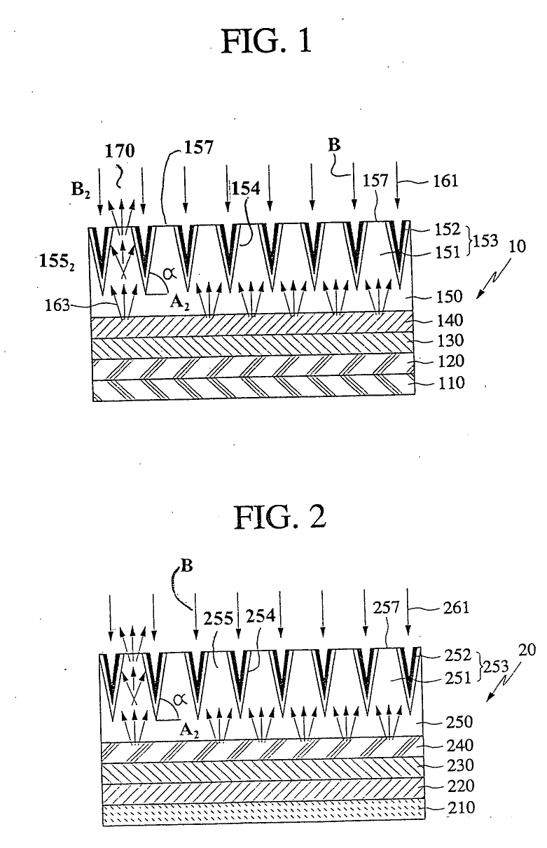

FIG. 1 is a partial cross-sectional view of an organic electroluminescent display device constructed as a first embodiment of the present invention, showing a cross-sectional construction of a front surface emitting organic electroluminescent display device.

As illustrated in FIG. 1, the organic electroluminescent display device of the first embodiment incorporates an electroluminescent (i.e., an “EL”) device 10. Electroluminescent device 10 includes an anode electrode 120, a light-emitting layer 130, and a transmissive cathode electrode 140, which are formed in sequence on one major surface of a transparent insulating substrate 110. The organic electroluminescent display device also has an encapsulation substrate 150 that serves to encapsulate electroluminescent device 10 and at the same time, to shield electroluminescent display device 10 from incident external light.

Encapsulation substrate 150 maybe constructed with a light-emitting element for focusing light emitted internally from light emitting layer 130 and emitting the focused light, and a light-shield to prevent incident external light from being received. The light-emitting element may use a plurality of protrusions 155 each having an aperture 157 on its top surface that is open to accommodate emission of the internally generated light that is emitted from light-emitting layer 130. Here, a slanted angle α between an inner surface of protrusion 155 and a line drawn parallel to the surface of light emitting layer 130, that is the substantially parallel base of encapsulation substrate 150, preferably ranges from approximately 45° to approximately 90°.

Furthermore, light-shield 153 is formed on a surface of each side wall 154 on each side of protrusions 155, except for the truncated exposed surfaces of the protrusions that form their apertures 157, that is, the exposed surfaces formed by the truncation of the apicies from the sidewalls 154 of each protrusion. Light-shield 153 includes a light-reflecting layer 151 for reflecting the internally generated light, and a light-absorbing layer 152 formed on the light-reflecting layer 151 to absorb rays of external light and ambient light generally indicated by arrows “B”. The light-reflecting layer 151 reflects the internal light indicated by arrows “A” emitted from the light-emitting layer 130. Light-reflecting layer 151 is formed of a metal film with an excellent reflectivity, such as aluminum, and with a thickness of approximately 60 to 5000 Å. Light-absorbing layer 152 serves to shield device 10 from the external light by absorbing the external light. The light-absorbing layer 152 may be constructed from a layer having a concentration gradient of metal and inorganic materials, for example, an MIHL (metal insulation hybrid layer) layer. Alternatively, light-absorbing layer 152 may be constructed from an organic black layer, an inorganic black layer, such as CᵣO₂, or a carbon black layer, among other materials.

The front surface 170 of a emitting organic electroluminescent display device constructed with the structure described in the foregoing paragraphs, external light “B” is absorbed by light-absorbing layer 152 formed on the side wall of each of protrusions 155, and the internally generated light “A” emitted from light-emitting layer 130 is reflected and focused by light-reflecting layer 151 formed on the side wall of each of the protrusions 155, so that the external light “B” is blocked from entering encapsulation substrate 150, and the internal light “A” is emitted via apertures 157 of each of protrusions 155, as light-emitting elements. Consequently, since only the external light “B” is blocked, while the internal light “A” is emitted via apertures 157 as it is without being obstructed by the light shield 153, contrast of the visual images is improved and at the same time, the efficiency of electroluminescent device 10 is increased.

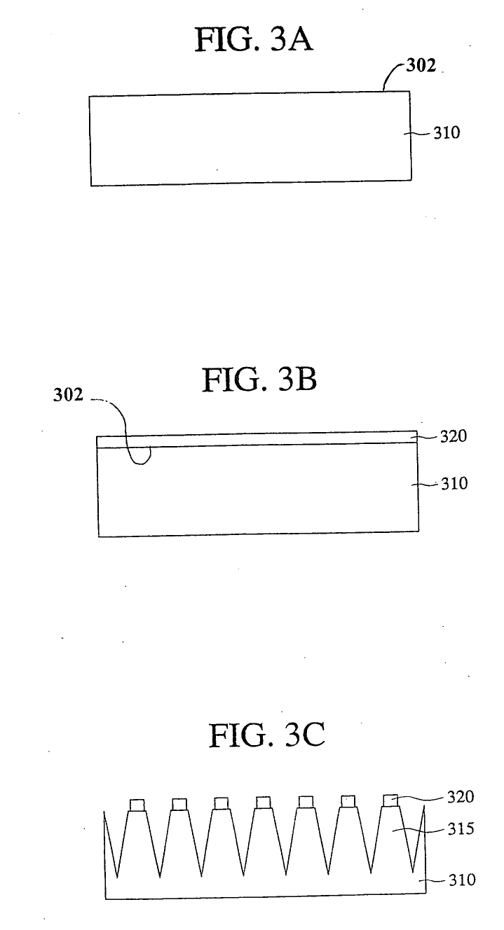

FIG. 2 is a sectional view of an organic electroluminescent display device constructed according to the principles of the present invention as a second embodiment of the present invention, showing a cross-sectional view of the structure of a rear surface emitting organic electroluminescent display device 20.

Referring to FIG. 2, organic electroluminescent display device 20 constructed as the second embodiment of the present invention is an electroluminescent device 20, with an anode electrode 240, a light-emitting layer 230, and a cathode electrode 220, which are formed in sequence on a transparent insulating substrate 250. Electroluminescent device 20 is encapsulated by an encapsulation substrate 210.

Substrate 250 incorporates a light-emitting element for focusing and emitting “A” generated by light-emitting layer 230, and a light-shield that prevents incident external light from entering transparent insulating substrate 250. The light-emitting element may be constructed with a plurality of protrusions 255 each having an aperture 257 on its top surface, for emitting internally generated light “A” emitted by light-emitting layer 230. Here, a slanted acute angle α is formed between protrusion 255 and light-emitting layer 230 that is, as measured against the planar base surface of substrate 250, preferably in the range of from approximately 45° to approximately 90°.

Further, light-shield 253 includes a light-reflecting layer 251 formed on a surface of the side wall of each of protrusions 255, except for its aperture 257, reflecting the internal light “A”, and a light-absorbing layer 252 formed on light-reflecting layer 251 absorbing the external light “B”. Light-reflecting layer 251 reflects the internal light “A” emitted from light-emitting layer 230. Light-reflecting layer 251 may be constructed from a metal film with an excellent reflectivity, such as aluminum, and with a thickness of between approximately 60 to 5000 Å. Light-absorbing layer 252 serves to absorb external light “B” so that the entry of impingent external light is blocked. Light-absorbing layer 252 may be constructed from an MIHL layer having a concentration gradient of metal and organic materials. Alternatively, light-absorbing layer 252 may be constructed from an organic black layer, an inorganic black layer, such as CᵣO₂, a carbon black layer, or similar, light-absorbing material.

In rear surface emitting organic electroluminescent display device 20 constructed with the foregoing structure, external light “B” is absorbed by light-absorbing layer 252 formed on the side wall 254 of each of protrusion 255, and the light emitted from light-emitting layer 230 is reflected and focused by light-reflecting layer 251 formed on the side wall of each of protrusions 255 so that the light is emitted via apertures 257. Consequently, since only the passage external light “B” blocked is shielded, while internal light “A” is emitted as it is without being shielded, the contrast of visual images formed by display device 20 is improved and efficiency increased.

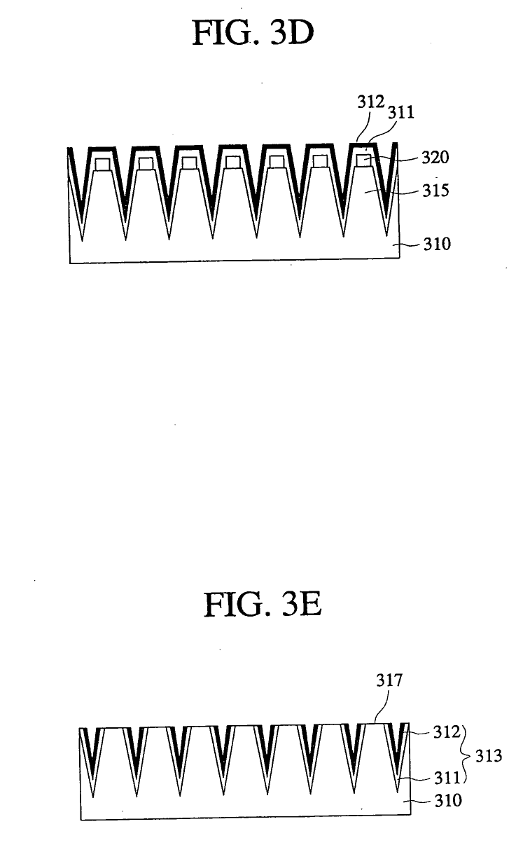

FIGS. 3A through 3E show cross-sectional elevational views explaining steps of a process II for manufacturing a transparent insulating substrate having a light-shielding function according to the principles of the present invention.

Transparent insulating substrate 310, such as a substrate made from a glass or a plastic material, is prepared as shown in FIG. 3A with an exposed major surface 302, and surface 302 is coated with a photosensitive film 320 as shown in FIG. 3B. Subsequently, as illustrated by FIG. 3C, photosensitive film 320 is patterned so that the conical or pyramid-shaped protrusions 315 of insulating substrate 310 are exposed except for portions of the substrate destined to be formed into apertures, as is shown in FIG. 3E. The exposed portions of the substrate 310 are shaped by, for example, laser-processing, molding processing, or the like, using photosensitive film 320 as a mask, to thereby form an array of spaced-apart, discrete protrusions 315.

A light-reflecting layer 311 and a light-absorbing layer 312 are deposited in sequence on the substrate as shown in FIG. 3D, and then the remaining photosensitive film 320 is removed, so that apertures 317 are respectively formed in an ordered array on the top surfaces of protrusions 315, and at the same time, a light-shield 313 is formed by light-reflecting layer 311 and light-absorbing layer 312, is selectively formed only on the side wall of each of the protrusions 315, as shown in FIG. 3E, leaving the truncated surfaces of the protrusions providing the light-emitting apertures 317.

Metal film with a high reflectivity may be used as the light-reflecting layer 311, while an organic black layer, an inorganic black layer, or a carbon black layer may be used as the light-absorbing layer 312. Alternatively, a metal-insulation hybrid layer (i.e., a MIHL layer) having a concentration gradient of metal and inorganic materials may be used as light-absorbing layer 312. Further, the light-shielding means 313 may be a triple-layer film of a thin metal film, a thin inorganic film and a thick metal film.

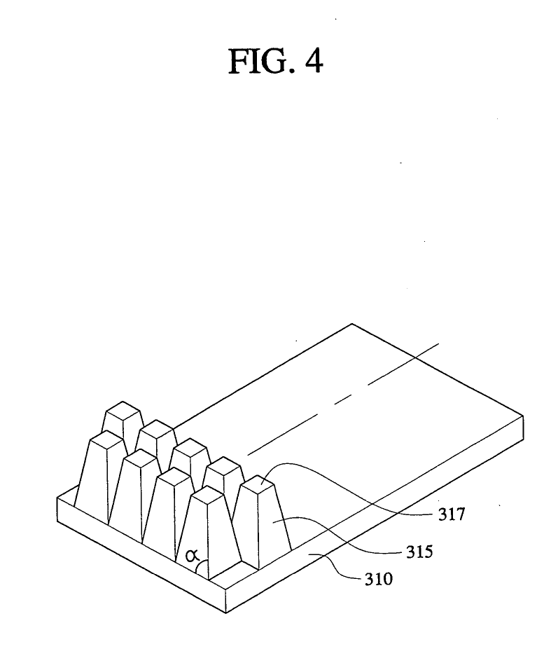

While substrate 310 having a light-shielding function may be formed with each of the protrusions shaped in the trigonal pyramidal form, as shown in FIG. 4, the protrusions may have any other shapes and forms only if each of the forms can reflect the internal light using light-shield 313 to accommodate emission of the light through the apertures and can shield the external light by absorbing it.

In the embodiment of the present invention, because an area of the device which is occupied by the apertures at which the light-shield is not formed is very small relative to the entire area of the device, the adverse influence of the reflection of the ambient and other external light may be almost neglected, resulting in a preparation of a light-shielding function for the substrate itself by the modified geometric structure of the substrate, such that the internal light is emitted through a front surface or alternatively, through a rear surface of the display device without loss of the internally generated light.

In the embodiments of the present invention, the light-shield includes the light-absorbing layer that absorbs impingent the external and ambient light and the light-reflecting layer that reflects the internally generated light.

Alternatively, as another embodiment, the light-shield maybe formed into a laminated film with a triple-layer structure of a thin metal layer, an inorganic layer, and a thick metal layer. The thin metal layer and the inorganic layer form a light-interfering layer and serve to shield the incident ambient and other external light by reflecting the incident light and eliminating the reflected light through destructive interference, respectively. Furthermore, the thick metal layer is a light-reflecting layer and serves to reflect the internal light emitted by the light-emitting layer and to accommodate passage of that internal light through the apertures at the truncated distal ends of the protrusions. Here, as the layer of a metal having an excellent reflectivity, such as aluminum, may be used for the thin metal layer that serves as the light-interfering layer and for the thick metal layer that serves as light reflecting layer 311, and an insulating film such as an oxide film may be used as the inorganic film.

In the several embodiments of the present invention, even though the protrusions are formed by directly processing either the substrate or the encapsulation substrate, and the light-shield is formed on the side walls of each of the plurality in the array of protrusions, any substrate, incorporating the protrusions where the light-shielding layer is formed as shown in FIGS. 1 and 2, may be used and separately constructed in the form of a film that may be attached to the conventional substrate and the conventional encapsulation substrate.

The practice of the present invention may also be adapted to an organic electroluminescent display device emitting light from both the front and rear surfaces by forming the protrusions and the light-shield on either the substrate or on an the encapsulation substrate. In the above-stated organic electroluminescent display devices constructed according to the principles of the present invention, there are advantages provided when the light-shielding layer is formed on the substrate to block impingent ambient or other external light, so that the contrast of the visual images produced by the device is improved and the efficiency is increased. Also, power consumption is reduced, which results in an extended lifetime of the flat panel display.

Although several preferred embodiments of the present invention have been disclosed for illustrative purposes the principles of the present invention, those skilled in the art will appreciate that various modifications, additions and substitutions are possible, without departing from the scope and spirit of the invention as disclosed in the accompanying claims.

What is claimed is:

1. A substrate for a flat panel display device, comprising:
a plurality of protrusions each including an aperture; and
a shielding film blocking incident light, the shielding film being formed on a surface of the substrate including the protrusions, except for the apertures.

2. The substrate according to claim 1, comprising a light-reflecting film formed under the light-shielding film.

3. The substrate according to claim 1, wherein a slanted angle between an inner side of each of the protrusions and the surface of the substrate ranges from 45° to 90°.

4. The substrate according to claim 1, wherein the light-shielding film is comprised of an organic black layer, an inorganic black layer, a carbon black layer, or a concentration gradient film having a concentration gradient of metal and transparent materials, absorbing the incident light.

5. The substrate according to claim 1, wherein the light-shielding film is comprised of a laminated layer structure of a metal film having a high reflectivity and an inorganic film, eliminating the incident light by interference.

6. The substrate according to claim 1, with the substrate comprising a glass or a plastic substrate.

7. The substrate according to claim 1, the substrate is a substrate, on which a display device is formed, or an encapsulation substrate.

8. A substrate for a flat panel display device, comprising:
a plurality of protrusions each including an aperture;
a light-reflecting film formed on a surface of the substrate including the protrusions, but not on the apertures; and
a light-absorbing film formed on the light-reflecting film.

9. A substrate for a flat panel display device, comprising:
a plurality of light-emitting elements formed integrally with the substrate each, of the light-emitting elements including an aperture; and
a light-shield formed on surfaces of the light-emitting elements, but not on the apertures.

10. The substrate according to claim 9, wherein the substrate is one of a substrate, on which a display device is formed, or an encapsulation substrate, the substrate being comprised of a glass or a plastic substrate.

11. The substrate according to claim 9, wherein the light-emitting elements each comprises:
a protrusion having the aperture on a distal surface, a slanted angle between an inner side of each of the protrusions and an surface of the substrate ranging from 45° to 90°; and
the light-shield is selectively formed on side walls of the protrusions except for the apertures.

12. The substrate according to claim 9, wherein the light-shield comprises:
a light-reflecting layer formed on side walls of the protrusions reflecting internally generated light; and a light-absorbing layer formed on the light-reflecting layer absorbing external light so that the substrate is shielded from the external light.

13. The substrate according to claim 12, wherein the light-reflecting layer is comprised of a metal film having a high reflectivity, and the light-absorbing layer is comprised of an organic black layer, an inorganic black layer, a carbon black layer, or a concentration gradient layer of metal and inorganic materials.

14. The substrate according to claim 9, wherein the light-shielding means comprising:
a light-reflecting layer formed on side walls of the protrusions for reflecting an internal light; and
a light-interfering layer formed on the light-reflecting layer shielding the substrate from external light by eliminating the external light by an interference.

15. The substrate according to claim 14, wherein the light-reflecting layer is comprised of a thicker metal film having a high reflectivity, and the light-interfering layer is comprised of a thinner metal film having a high reflectivity and an inorganic film.

16. A flat panel display device, comprising:
a substrate;
a display device formed on the substrate; and
an encapsulation substrate for encapsulating the display device,
at least one of the substrate and the encapsulation substrate comprising a plurality of discrete protrusions emitting light generated internally with the display device, each of the protrusions including an aperture on a top surface; and
a light-shield selectively formed only on side walls of the protrusions.

17. The flat panel display device according to claim 16, wherein the substrate or encapsulation substrate is a glass or a plastic substrate.

18. The flat panel display device according to claim 16, wherein the light-shield comprises:
a light-reflecting layer formed on a side wall of each of the protrusions, the light-reflecting layer is comprised of a metal film having a high reflectivity; and
a light-shielding layer formed on the light-reflecting layer, wherein the light-shielding layer comprised of an organic black layer, an inorganic black layer, a carbon black layer, or a concentration gradient layer of metal and inorganic materials to shield by absorbing the external light, or is comprised of a thin metal and inorganic films to shield the external light by eliminating it using an interference of the external light.

19. The flat panel display device according to claim 16, wherein the protrusions are formed integrally with the substrate, and
a slanted angle between an inner side of each of the protrusions and the surface of the substrate ranges from 45° to 90°.

20. A flat panel display device, comprising:
a substrate;
a display device formed on the substrate;
an encapsulation substrate encapsulating the display device; and
a light-shielding film attached on at least one of the substrate and the encapsulation substrate,
comprising a plurality of discrete protrusions emitting a light emitted from the display device, each of the protrusions including an aperture on a top surface, and a light-shielding means selectively formed only on side walls of the protrusions.

21. The flat panel display device according to claim 20, wherein the light-shielding film comprises:
a light-reflecting layer selectively formed only on side walls of the protrusions, the light-reflecting layer is comprised of a metal film having a high reflectivity; and
a light-shielding layer formed on the light-reflecting layer, the light-shielding layer comprised of an organic black layer, an inorganic black layer, a carbon black layer, or a concentration gradient layer of a metal and inorganic materials to shield the external light by absorbing it, or is comprised of a thin metal and inorganic films for shielding the device from the external light by interference of the external light.

22. The flat display device according to claim 20, wherein the protrusions are formed integrally with the film, and
a slanted angle between an inner side of each of the protrusions and the film ranges from 45° to 90°.
